(19) United States
(12) Patent Application Publication
(10) Pub. No.: US 2015/0114952 A1
(43) Pub. Date: Apr. 30, 2015

(54) FLEXIBLE TRANSPARENT FILM HEATER

(71) Applicant: NATIONAL TSING HUA UNIVERSITY, Hsinchu City (TW)

(72) Inventors: Nyan-Hwa TAI, Hsinchu City (TW); Yu-An LI, Zhongli City (TW)

(73) Assignee: NATIONAL TSING HUA UNIVERSITY, Hsinchu City (TW)

(21) Appl. No.: 14/264,309

(22) Filed: Apr. 29, 2014

(30) Foreign Application Priority Data
Oct. 24, 2013 (TW) 102138467

(51) Int. Cl. H05B 3/14; H05B 3/34

(52) U.S. Cl. CPC H05B 3/146; H05B 3/34; Y10S 977/932; B82Y 30/00
USPC 219/549; 977/932

(57) ABSTRACT

A flexible transparent film heater includes an electrically conductive polymer matrix and a conductive filler dispersed uniformly in the electrically conductive polymer matrix and containing a plurality of metal-deposited carbon nano-particles, each of which contains a carbon nano-particle and a metal deposit that is deposited on and that is bonded to the carbon nano-particle through ionic bonding.

### CROSS-REFERENCE TO RELATED APPLICATION

This application claims priority of Taiwanese application no.102138467, filed on Oct. 24, 2013.

### BACKGROUND OF THE INVENTION

1. Field of the Invention

This invention relates to a flexible transparent film heater, more particularly to a flexible transparent film heater containing metal-deposited carbon nano-particles.

2. Description of the Related Art

Transparent film heaters have been adopted for defrosting and warming apparatus, such as automobile mirrors, refrigerator windows, outdoor panel displays, helmet windows, and electronic devices in harsh environments. A typical commercial film-like heater is a metallic wire made from an iron-chromium-aluminum-based (Fe—Cr—Al-based) alloy. However, the disadvantages of this alloy, such as its opacity, rigidity, weight, low heating efficiency, low infrared emissivity, and slow heat diffusion, limit its applications.

A patterned copper foil thin film is another kind of commercial metallic film heater. It also suffers from similar shortcomings. In addition, since copper and its alloy have a high rigidity, they are not easy to conform to a curved surface, and the opaque character makes them unsuitable for use in transparent devices.

Indium tin oxide (ITO) film has been widely used to replace the Fe—Cr—Al-based alloy and the patterned copper foil thin film because it possesses the characteristics of optical transparency, high electrical conductivity, and an electrothermal heating effect. However, the drawbacks of the ITO film heater include slow thermal response, limited resources of indium, intolerance to acid or base, and brittleness under bending deformation, causing the ITO film heater to be unpopular.

A transparent film heater made of other materials, such as gallium-doped zinc oxide (ZnO:Ga), silver (Ag) nanowire, carbon nanotube (CNTs), or graphene, has been investigated due to advantages, including acceptable optoelectronic performance, lower material cost, and a relatively lower deposition temperature compared to that of ITO film. However, there is still a need for a flexible transparent film heater having excellent electro-thermal performance through heat conduction and infrared radiation.

### SUMMARY OF THE INVENTION

Therefore, the object of the present invention is to provide a flexible transparent film heater that can overcome at least one of the aforesaid drawbacks associated with the prior art.

According to the present invention, there is provided a flexible transparent film heater. The flexible transparent film heater includes an electrically conductive polymer matrix and a conductive filler dispersed uniformly in the electrically conductive polymer matrix and containing a plurality of metal-deposited carbon nano-particles, each of which contains a carbon nano-particle and a metal deposit that is deposited on and that is bonded to the carbon nano-particle through ionic bonding.

### BRIEF DESCRIPTION OF THE DRAWINGS

In drawings which illustrate an embodiment of the invention,

FIG. 1 is a plot of thermal conductivity and sheet resistance for Example 1 and Comparative Examples 1 to 3 having a thickness of 80 nm;

FIG. 2 is a SEM diagram illustrating the surface morphology of Example 1;

FIG. 3 is a SEM diagram illustrating the surface morphology of Comparative Example 2;

FIG. 4 is a SEM diagram illustrating the surface morphology of Comparative Example 3;

FIG. 5 is a plot of the thermal conductivity and sheet resistance versus transmittance at a wavelength of 550 nm of Example 1;

FIG. 6 is a plot of the temperature of the film surface versus time, showing the temperature of the film surface having a thickness of 100 nm in the case of power-on and power-off of Example 1;

FIG. 7 is a plot of ΔT_{steady-state} and sheet resistance versus transmittance at 550 nm of Example 1 (thickness of the film heater is 100 nm);

FIG. 8 is a plot of the (Rₓ−R₀/R₀)×100% and (Tₓ−T₀/T₀)×100% versus time of Example 1;

FIG. 9 shows an infrared emissive (E) spectra from 4-14 μm of Example 1 at room temperature (ΔT_{steady-state} is 0° C.) and under a condition that no DC voltage was applied;

FIG. 10 shows a infrared emissive (E) spectra from 4-14 μm of Example 1 at 63° C. (ΔT_{steady-state} is 35° C.). and under a DC voltage of 8.0 V;

FIG. 11 shows a infrared emissive (E) spectra from 4-14 μm of Example 1 at 110° C. (ΔT_{steady-state} is 82° C.). and under a DC voltage of 10.0 V;

FIG. 12(a) is a photo showing a flat mode of the film heater of Example 1, and FIG. 12(b) is an optical and infrared thermal image of the flat mode of the film heater of Example 1 having thickness of 100 nm at T_{steady-state} and under a DC voltage of 10.0 V; and

FIG. 13 (a) is a photo showing a bending mode of the film heater of Example 1, and FIG. 13(b) is an optical and infrared thermal image of the bending mode of the film heater of Example 1 having thickness of 100 nm at T_{steady-state} and under a DC voltage of 10.0 V.

### DETAILED DESCRIPTION OF THE PREFERRED EMBODIMENT

The preferred embodiment of a flexible transparent film heater of this invention includes an electrically conductive polymer matrix and a conductive filler dispersed uniformly in the electrically conductive polymer matrix and containing a plurality of metal-deposited carbon nano-particles. Each of the metal-deposited carbon nano-particles contains a carbon nano-particle and a metal deposit that is deposited on and that is bonded to the carbon nano-particle through ionic bonding.

The metal deposits on the carbon nano-particles not only provide more electrical contact paths in the flexible transparent film heater but also increase thermal conduction efficiency of the flexible transparent film heater and reduce the interfacial resistance to heat flow between the polymer matrix and the conductive filler. In addition, by first depositing the metal deposits on the carbon nano-particles to form the conductive filler, followed by dispersing the conductive filler into the polymer matrix, sedimentation or aggregation of the metal deposits in the polymer matrix can be avoided.

The conductive filler is preferably in an amount ranging from 2 wt % to 10 wt %, based on the total weight of the polymer matrix and the conductive filler.

Examples of the carbon nano-particles of the metal-deposited carbon nano-particles include carbon nanotubes, graphite, graphene nanosheet and carbon nanopowder.

In one preferred embodiment, the carbon nano-particles are carbon nanotubes.

In another preferred embodiment, the carbon nano-particles are carbon nanotubes and graphene nanosheets. By using a proper ratio of one-dimensional few-walled metal-deposited carbon nanotubes and two-dimensional metal-deposited graphene nanosheets, a three-dimensional hybrid structure can be constructed in the polymer matrix. The three-dimensional hybrid structure effectively reduces the electrical resistance, and provides a thermal network path to quickly dissipate the heat generated by the film heater in all directions.

In order to enhance the uniformity of thermal conductivity of the flexible transparent film heater, the weight ratio of carbon nanotubes (CNT) to graphene nanosheets (GN) preferably ranges from 0:10 to 10:0, more preferably from 1:4 to 1:0.6.

It is noted that the compatibility between the polymer matrix and the conductive filler can be further improved through modification of the carbon nano-particles. The carbon nano-particles may be modified to carry functional groups on the surfaces thereof. Examples of the functional group include carboxyl group (—COOH), hydroxyl (—OH), and amide group (—CONHR). The modification may be conducted in a conventional manner.

Preferably, the metal deposit is silver deposit. Silver is an excellent thermal and electrical conductor.

The metal-deposited carbon nano-particles preferably have a particle size ranging from 1 to 10 nm, more preferably ranging from 3 to 7 nm.

Preferably, the polymer matrix is made from a polymer selected from the group consisting of poly(3,4-ethylenedioxythiophene)-poly(4-stryrenes ulfonate) (PEDOT:PSS), polyaniline, polypyrrole, and polyacetylene. PEDOT:PSS has high optical transmittance, low electrical resistance and low thermal resistance.

The flexible transparent film heater of the present invention is suitable for defrosting and warming applications. For defrosting applications, the flexible transparent film heater of the present invention can remove mist by its superior properties of direct contact (heat conduction) and infrared radiation. Since the film heater is flexible, it can be directly attached to a curved surface of a substrate. The polymer matrix may be coated on a substrate, such as a plastic substrate, a glass substrate, or a ceramic substrate.

Preferably, the flexible transparent film heater has a transmittance greater than 80%.

The merits of the flexible transparent film heater of this invention will become apparent with reference to the following Example and Comparative Examples.

### EXAMPLES

### Example 1 (EX1)

### Preparation of the conductive filler

Carbon nanotubes (CNTs) (available from XinNano Materials Co., Ltd., catalog no.: XNM-HP-12050, average diameter was 40.0 nm, 86.0% purity) and graphene nanosheets (GNs) were respectively purified based on the procedures disclosed in Y. A. Li, N. H. Tai, S. K. Chen, T. Y. Tsai, ACS Nano 2011, 5, 6500 and Y. J. Chen, Y. A. Li, M. C. Yip, N. H. Tai, Comps. Sci. Tech. 2013, 80, 80.

The purified carbon nanotubes and graphene nanosheets were separately functionalized by immersing into a 3:1 v/v mixture of concentrated H₂SO₄ and HNO₃, followed by sonication for an hour. The functionalized carbon nanotubes and graphene nanosheets were then collected by vacuum filtration and were washed with copious amounts of deionized water until the wash water reached a pH of 7.0 to obtain the functionalized carbon nanotubes (f-CNTs) and graphene nanosheets (f-GNs).

In one beaker, the f-CNTs were uniformly dispersed in ethanol and were subjected to sonication for an hour. In another beaker, an ethanol solution containing 10.0 mM silver nitrate was prepared and was subjected to sonication for an hour. These two solutions were mixed together, followed by sonication for an hour to obtained silver-deposited carbon nanotubes (Ag@f-CNTs). The Ag@f-CNTs were then filtered and dried under 150° C. for 24 hours. The f-GNs were treated by the same process as the f-CNTs so as to obtain silver-deposited graphene nanosheets (Ag@f-GNs). In this embodiment, silver was bonded to the carbon nanotubes and graphene nanosheets through ionic bonding.

### Preparation of the Flexible Transparent Film Heater

A concentrated PEDOT:PSS solution (available from HC Starck, catalog no.: PH500, having a solid content of 10.0 mg/mL), was prepared.

18.0 mL of ethanol and 2.0 mL of the concentrated PEDOT:PSS solution were mixed and were subjected to sonication for an hour to form a uniform solution.

2 mg of a conductive filler was then added into the solution to obtain a mixture. The concentration of the conductive filler was approximately 10.0 wt % based on the total weight of the mixture. The conductive filler contained Ag@f-CNTs and Ag@f-GNs. The weight ratio of Ag@f-CNTs to Ag@f-GNs was 1:4.

After subjecting the mixture to sonication for an hour, the mixture was subjected to centrifugation at 10000 rpm in a Kubota 7780 centrifuge for another hour to obtain an upper layer supernatant.

The upper layer supernatant thus obtained was coated on a PET substrate having a thickness of 125 μm, followed by drying at 120° C. for 60 seconds to form the transparent film heater of Example 1.

### Comparative Example 1 (CE1)

The procedures and conditions in preparing the flexible transparent film heater of Comparative Example 1 were similar to those of Example 1 except that the film heater of Comparative Example 1 was free of the conductive filler.

### Comparative Example 2 (CE2)

### Preparation of Flexible Transparent Film Heater

The procedures and conditions in preparing the flexible transparent film heater of Comparative Example 2 were similar to those of Example 1 except that the carbon nanotubes and the graphene nanosheets of the conductive filler of Comparative Example 2 were free of the functional groups and the metal deposits.

### Comparative Example 3 (CE3)

### Preparation of Flexible Transparent Film Heater

The procedures and conditions in preparing the flexible transparent film heater of Comparative Example 3 were similar to those of Example 1 except that the carbon nanotubes and the graphene nanosheets of the conductive filler of Comparative Example 3 were free of the metal deposits.

### <Performance Test>

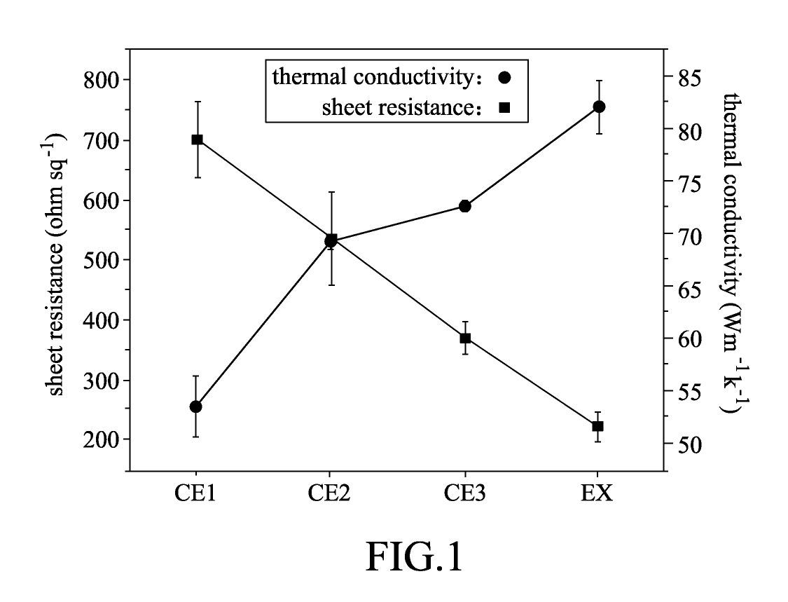

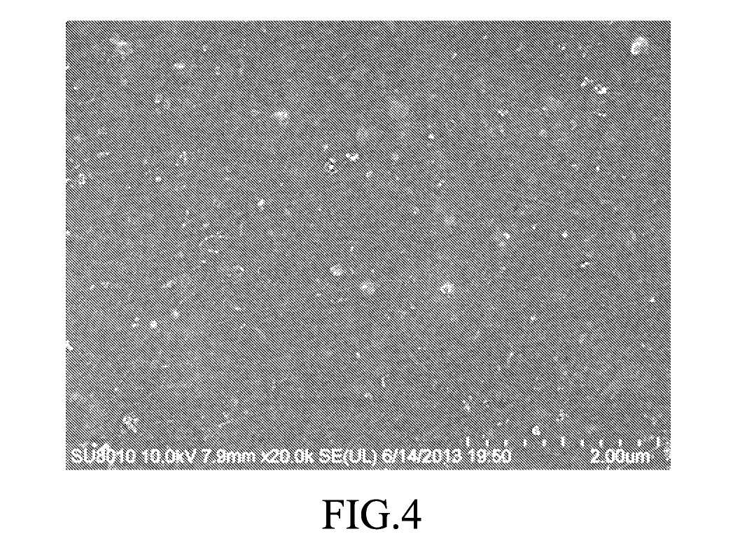

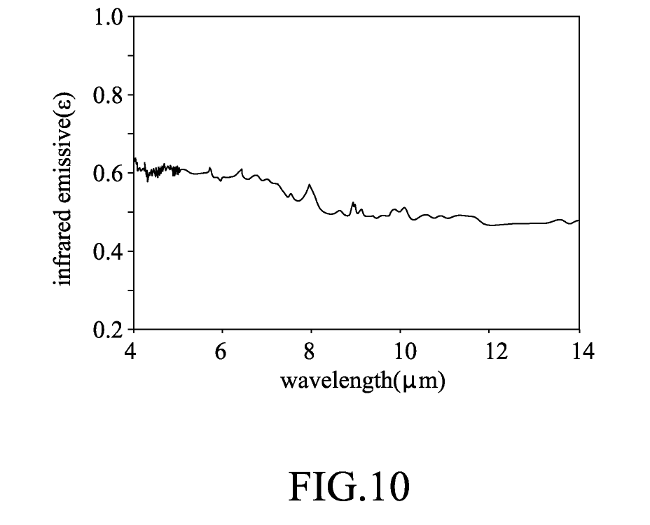

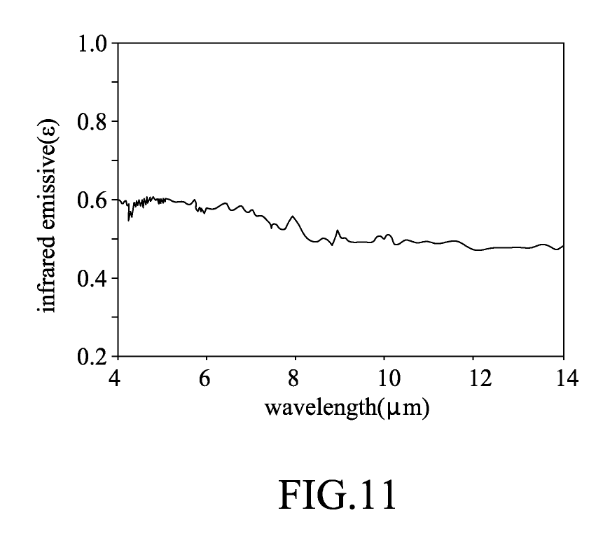

The sheet resistance, transmittance, thermal conductivity and radiation emissivity of the flexible transparent film heater of the aforesaid Example and Comparative Examples were measured. The results are shown in FIGS. 1 to 13.

The sheet resistance, thermal conductivity and radiation emissivity of the flexible transparent film heater were measured by connecting two ends of the flexible transparent film heater to a DC power source, followed by applying a voltage across the ends of the flexible transparent film heater.

FIG. 1 and Table 1 show the sheet resistances and thermal conductivities (κ) of Example 1 and Comparative Examples 1 to 3 (having a film thickness of 80 nm). The thermal conductivity κ is increased by approximately 60% from 53.5±3.0 W/mk (Comparative Example 1) to 82.1±2.5 W/mk (Example 1). The sheet resistance is decreased by approximately 70% from 700.0±62.9 ohm/sq (Comparative Example 1) to 222.0±25.6 ohm/sq (Example 1). These results indicate that the thermal conductivity κ increases with the electrical conductivity.

TABLE 1

| | Sheet resistance | Thermal conductivity |
|---|---|---|
| | (ohm/sq) | (κ) (W/mk) |
| EX1 | 222.0 | 82.1 |
| CE1 | 700.0 | 53.5 |
| CE2 | 536.0 | 69.2 |
| CE3 | 371.0 | 72.7 |

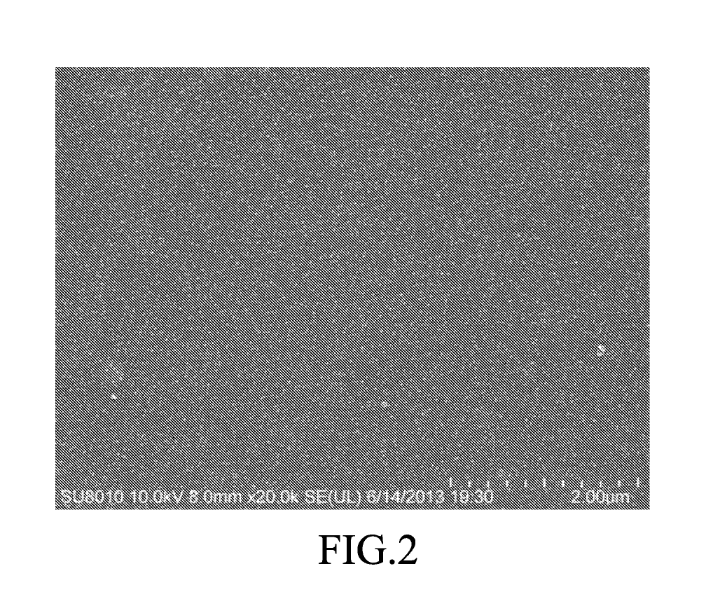

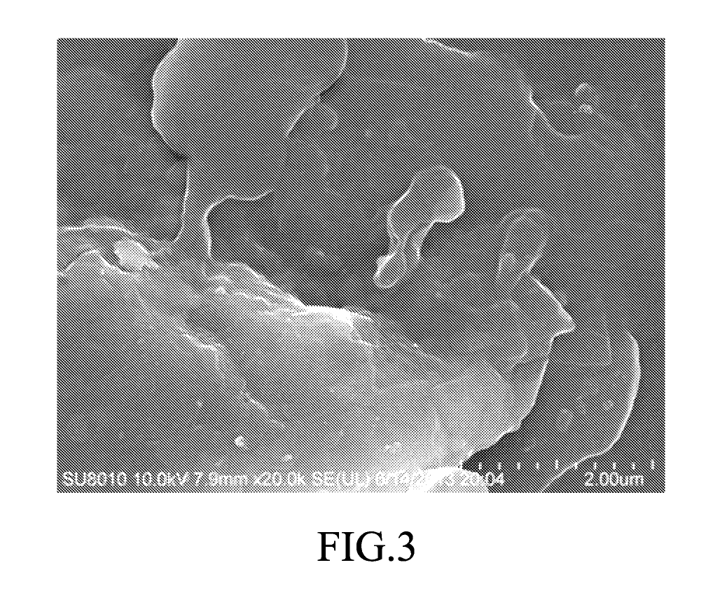

FIGS. 2 to 4 illustrate the surface morphology of the film heater for Example 1 and Comparative Examples 2 and 3, respectively. Several discontinuous zones are observed in FIG. 3, which is an indication of a poor compatibility between the electrically conductive polymer matrix and the conductive filler, and which may result in undesired phonon scattering effect and a decrease in the thermal conductivity efficiency.

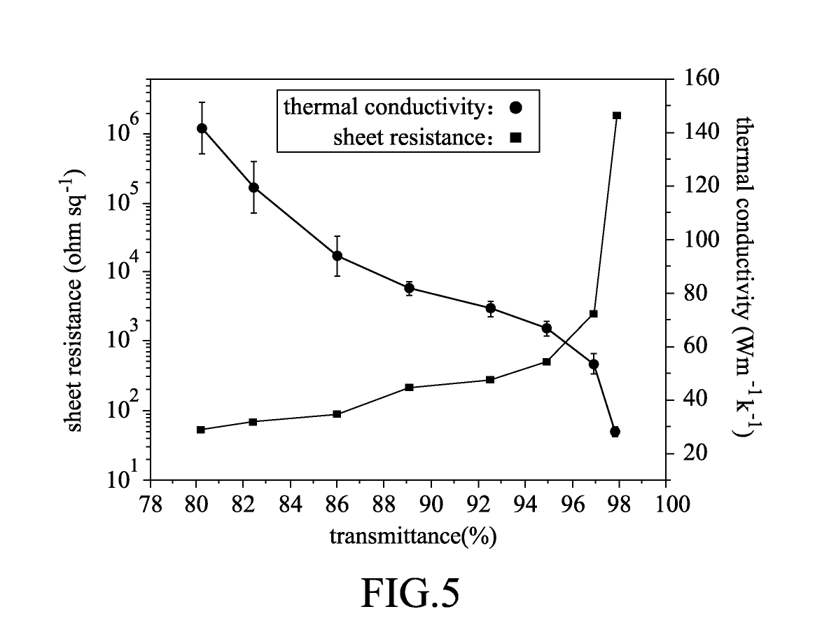

FIG. 5 shows the sheet resistance and the thermal conductivity κ of the film heater of Example 1 for different transmittances at a wavelength of 550 nm. The transmittance of the film heater is a function of the thickness of the film heater. The transmittances of the data points shown in FIG. 5, which correspond to the thicknesses 10, 20, 40, 60, 80, 100, 120, and 140 nm of the film heater, are 97.8%, 96.9%, 94.9%, 92.5%, 89.0%, 86.0%, 82.4%, and 80.2%, respectively. Among the data points, the film heater having a thickness of 140 nm has a remarkable thermal conductivity κ of 142.0±9.6 W/mk, a sheet resistance of 53.0±4.2 ohm/sq, and a transmittance of 80.2±0.8% at 550 nm.

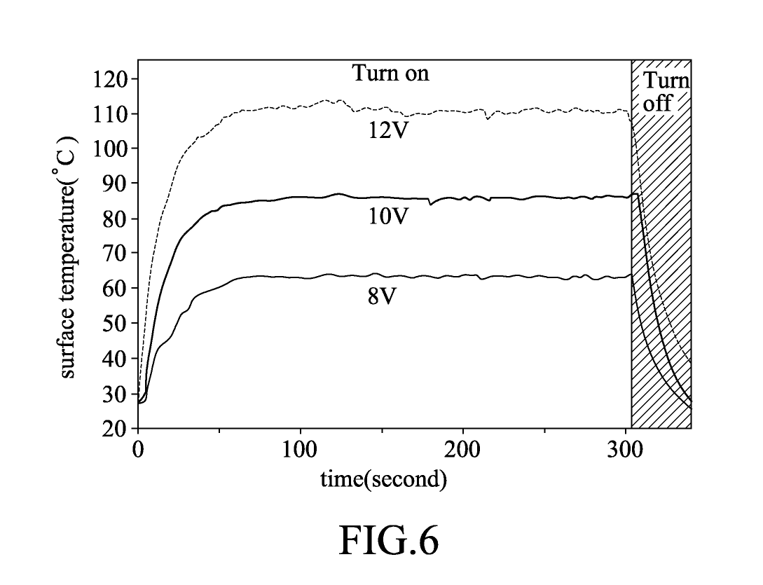

FIG. 6 shows the response time of the film heater of Example 1 having a thickness of 100 nm under different applied DC voltages (8 V, 10 V and 12 V). The film heater of Example 1 under test has a sheet resistance of 93.1 ohm/sq and a transmittance of 86.2% at 550 nm. The results show that the film heater has a response time of within 60 seconds. The response time is defined as the time to reach a steady-state temperature T_{steady-state} from room temperature. As shown in FIG. 6, the steady-state temperature (T_{steady-state}) of the film heater increased from 62.5 to 109.5° C. while the power voltage increased from 8.0 to 12.0 V, the response time of the film heater is independent of the applied DC voltage, and after removal of the applied DC voltage, the film heater dissipates heat effectively, and is cooled to room temperature in a relatively short time.

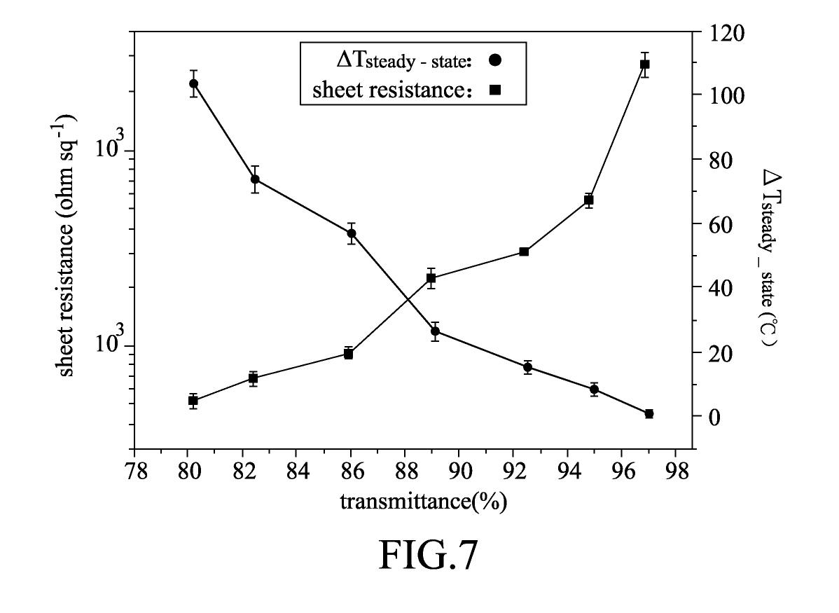

FIG. 7 shows a plot of the electrothermal performance of the film heater of Example 1 at different film transmittances (i.e., having different thicknesses). The steady-state temperature difference (ΔT_{steady-state}) shown in FIG. 7 is defined as the temperature difference between T_{steady-state} and room temperature. The results show that ΔT_{steady-state} is a function of the thickness of the film heater, and that a lower sheet resistance generates a higher ΔT_{steady-state} under the same applied DC voltage.

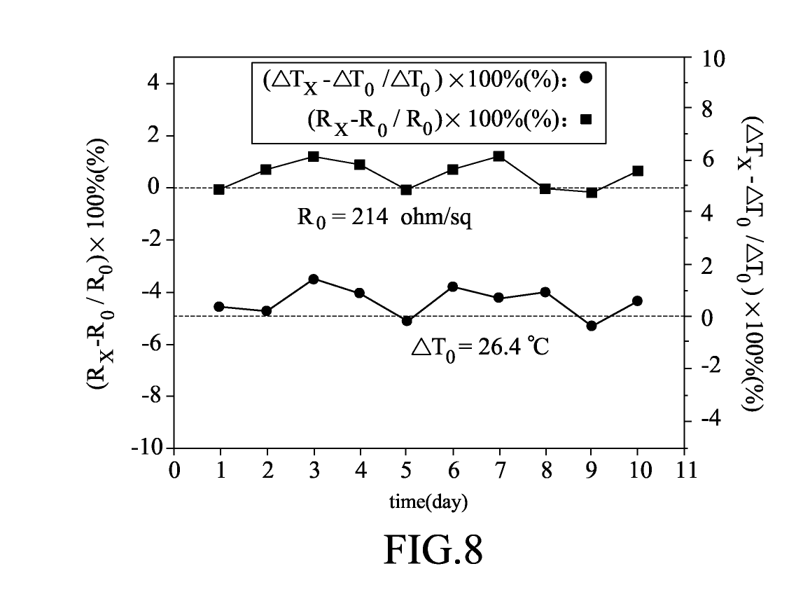

FIG. 8 shows the stability of the film heater of Example 1 having a thickness of 80 nm under an applied DC voltage of 10.0 V. The film heater of Example 1 has a sheet resistance of 214.0 ohm/sq and a transmittance of 89.0% at 550 nm. In FIG. 8, R₀ is defined as the initial sheet resistance at room temperature, Rₓ is defined as the sheet resistance under the applied DC voltage for a period of time, (ΔTₒ is defined as the temperature difference between a steady-state temperature at an initial time and room temperature, and ΔT is the temperature difference between a steady temperature after a period of time and room temperature. The film heater of Example 1 shows a stable heating performance for a continuous and long heating time.

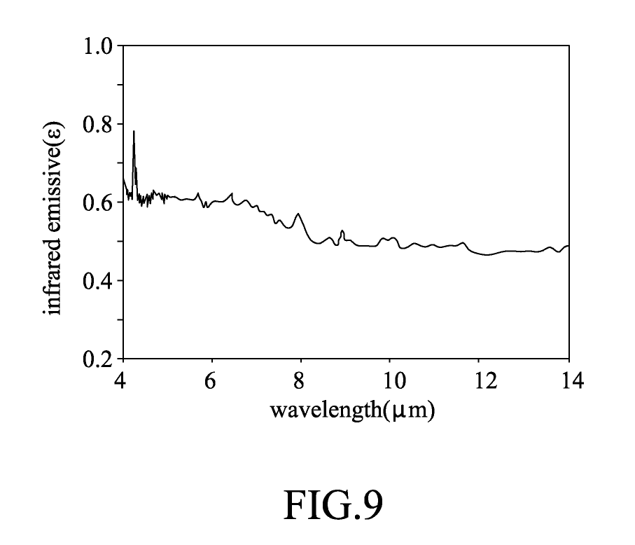

FIGS. 9 to 11 show infrared emissive (ε) spectra at the wavelength range of 4-14 μm for the film heater of Example 1 with a thickness of 100 nm at a room temperature of 28.0° C. under different applied DC voltages (0 V, 8 V, and 12 V). The steady-state temperature differences ΔT_{steady-state} of the film heater obtained under 0 V, 8 V, and 12 V are 0, 35.0, and 82.0° C., respectively. FIGS. 9 to 11 show the average is about 0.53. The of the film heater of Example is almost independent of ΔT_{steady-state}, and substantially does not change with the applied DC voltage. The ε of the ITO film is approximately 0.1 to 0.3, which is much lower than that of Example 1. Hence, the film heater of the present invention exhibits a good heat emission through infrared radiation.

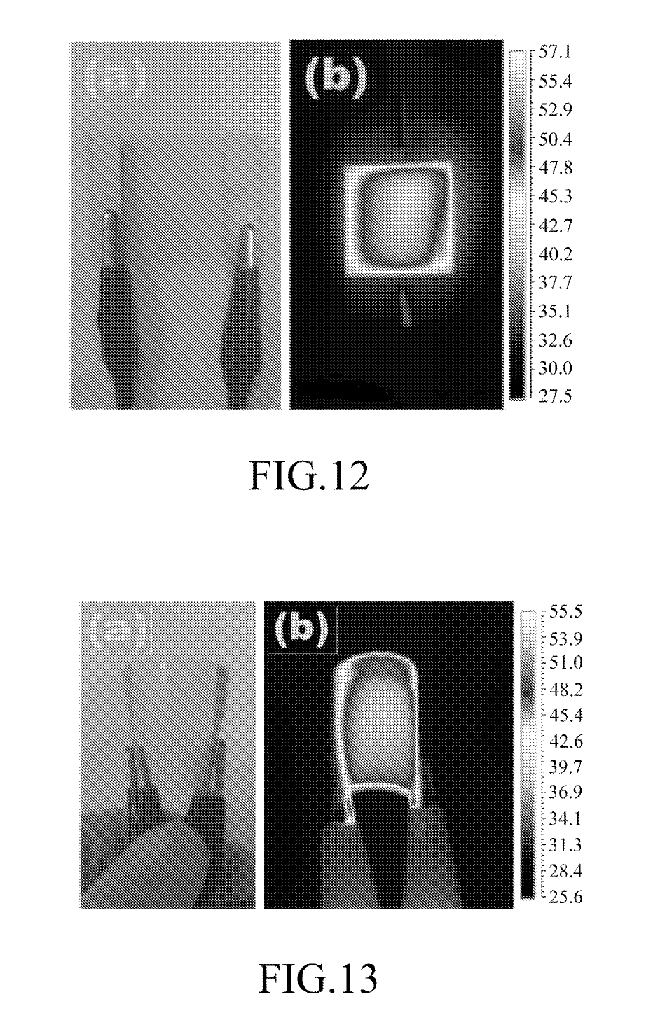

FIGS. 12 and 13 respectively show the pictures of optical image (in a power off state) and infrared thermal image (in a power on state) for non-bent and bent modes of the film heater of Example 1. The images show homogeneous heat distribution in both non-bent and bent modes.

In conclusion, by using the metal-deposited carbon nano-particles as the conductive filler dispersed uniformly in the polymer matrix, the flexible transparent film heater of the present invention may exhibit superior transparency and flexibility, high thermal conductivity and infrared emissivity, a quick response time, stable heating performance, and uniform heat dissipation.

With the invention thus explained, it is apparent that various modifications and variations can be made without departing from the spirit of the present invention. It is therefore intended that the invention be limited only as recited in the appended claims.

What is claimed is:

1. A flexible transparent film heater comprising:
an electrically conductive polymer matrix; and
a conductive filler dispersed uniformly in said electrically conductive polymer matrix and containing a plurality of metal-deposited carbon nano-particles, each of which contains a carbon nano-particle and a metal deposit that is deposited on and that is bonded to said carbon nano-particle through ionic bonding.

2. The flexible transparent film heater as claimed in claim 1, wherein said metal-deposited carbon nano-particles are metal-deposited carbon nanotubes.

3. The flexible transparent film heater as claimed in claim 2, wherein said conductive filler further includes a plurality of metal-deposited graphene nanosheets.

4. The flexible transparent film heater as claimed in claim 3, wherein, based on the total weight of said polymer matrix and said conductive filler, said conductive filler is in an amount ranging from 2 wt % to 10 wt %.

5. The flexible transparent film heater as claimed in claim 1, wherein said metal deposit is silver deposit.

6. The flexible transparent film heater as claimed in claim 1, wherein said metal-deposited carbon nano-particles have a particle size ranging from 1 to 10 nm.

7. The flexible transparent film heater as claimed in claim 1, wherein said electrically conductive polymer matrix is made from a polymer selected from the group consisting of poly(3,4-ethylenedioxythiophene)-poly(4-stryrenes ulfonate, polyaniline, polypyrrole, and polyacetylene.

8. The flexible transparent film heater as claimed in claim 1 having a transmittance greater than 80%.

9. The flexible transparent film heater as claimed in claim 1, further comprising a substrate, said electrically conductive polymer matrix being coated on said substrate.
